(19) United States
(12) Patent Application Publication
(10) Pub. No.: US 2013/0032413 A1
(43) Pub. Date: Feb. 7, 2013

(54) BODYWEIGHT DISTRIBUTION AND POSTURE EVALUATION SYSTEM AND METHOD

(71) Applicants: Damian Jerard SMITH, Denison, TX (US); Kyle Garner Timm, Denison, TX (US)

(72) Inventors: Damian Jerard SMITH, Denison, TX (US); Kyle Garner Timm, Denison, TX (US)

(21) Appl. No.: 13/196,458

(22) Filed: Aug. 2, 2011

(51) Int. Cl. G01G 19/00; G06F 15/00; G01G 19/50; G01G 19/52

(52) U.S. Cl. 177/1; 177/50; 702/173; 177/201

(57) ABSTRACT

A system, method, and apparatus for bodyweight distribution and posture evaluation. A pressure sensitive bilateral scale or mat determines pressure applied by each lower extremity of a person. Observable posture is evaluated with plumb line measurements of a person from at least one of the lateral, anterior, or posterior views. Accessory weight distribution devices evaluate weight that is distributed on surfaces other than the pressure sensitive bilateral scale or mat. A computer processing system may record, analyze and/or display weight distribution and/or posture readings and evaluation results.

### FIELD OF THE DISCLOSURE

The invention relates to personal training and physical therapy. More specifically, this invention relates to a system and method to evaluate a person's bodyweight distribution and posture in conjunction with personal training or physical therapy.

### BACKGROUND

In personal training and/or physical therapy, a person's balance may indicate a tendency to favor using one part of the body over another to hold weight. Favoring one part of the body may inhibit the development of physical attributes, and may cause harm by increasing the wear on the favored part of the body. Evidence of a lack of equilibrium in a person's balance may currently be evaluated by visually inspecting a person's posture. However, such an evaluation requires an experienced evaluator to give an opinion based upon what they can see, and may lead to inaccurate evaluations based upon the person's efforts to demonstrate balance to the evaluator during the evaluation. For example, a person may be able to maintain appearances of balance even though they are placing the majority of their weight on one part of the body.

Single plated scales, like the WiiFit Balance Board, do not provide sufficient accuracy to identify a person's specific balance difference, and does not provide the capability to monitor incremental changes in a person's balance that may be beneficial and/or necessary in physical training and physical therapy development. Systems for mapping pressure distribution in seats and beds help in prescribing proper seating and/or bedding options for patients, and are not designed to evaluate a person's posture and balance in a physical training and/or therapy environment, such as a chiropractic care or rehabilitation center.

### SUMMARY

The present disclosure describes an apparatus, system and method for accurately evaluating posture and balance in a physical training and therapy environment. The apparatus includes a dual-sided scale with independent compression sensors to register the weight placed upon each plate. The scale allows for the monitoring incremental bodyweight distribution through a person's lower extremities. The scale is associated with at least one display to provide feedback regarding the compression measurements and weight distribution in each plate of the scale.

The scale may also be associated with a computer system that processes a person's compression measurements. The system may also store additional historical compression measurements for a person in order to provide an historical analysis of changes in a person's compression measurements and indications of changes in how a person is distributing weight across their lower extremities.

In addition, the system may include posture measuring tools to determine a person's alignment in the lateral, posterior/anterior planes. Evaluating a person's physical posture in conjunction with their weight distribution may improve corrective physical therapies and physical training.

The system may also include weight distribution accessories that permit analysis of weight distribution in the upper extremities. Additional weight distribution in the upper extremities may be due to a person's reliance on additional support structures to relieve weight on the lower extremities.

In addition, the system may include components that allow a determination of weight distribution during physical activities such as walking, jumping, and/or other exercises or everyday activities.

Additional aspects, advantages and features of the present invention are included in the following description of exemplary examples thereof, which description should be taken in conjunction with the accompanying figures, wherein like numerals are used to describe the same feature throughout the figures.

### A BRIEF DESCRIPTION OF THE DRAWINGS

FIG. 1 is a top view of an embodiment of the a bodyweight distribution and posture evaluation device of the present disclosure;

FIG. 2 is a side view of an embodiment of the a bodyweight distribution and posture evaluation device of the present disclosure with a display;

FIG. 3 is a bottom view of an embodiment of the a bodyweight distribution and posture evaluation device of the present disclosure;

FIG. 4 shows a second embodiment of a bodyweight distribution and posture evaluation system the present disclosure;

FIG. 5 shows a third embodiment of a bodyweight distribution and posture evaluation system the present disclosure;

FIG. 6 shows a fourth embodiment of a bodyweight distribution and posture evaluation system the present disclosure;

FIG. 7 shows a fifth embodiment of a bodyweight distribution and posture evaluation system the present disclosure;

### DETAILED DESCRIPTION

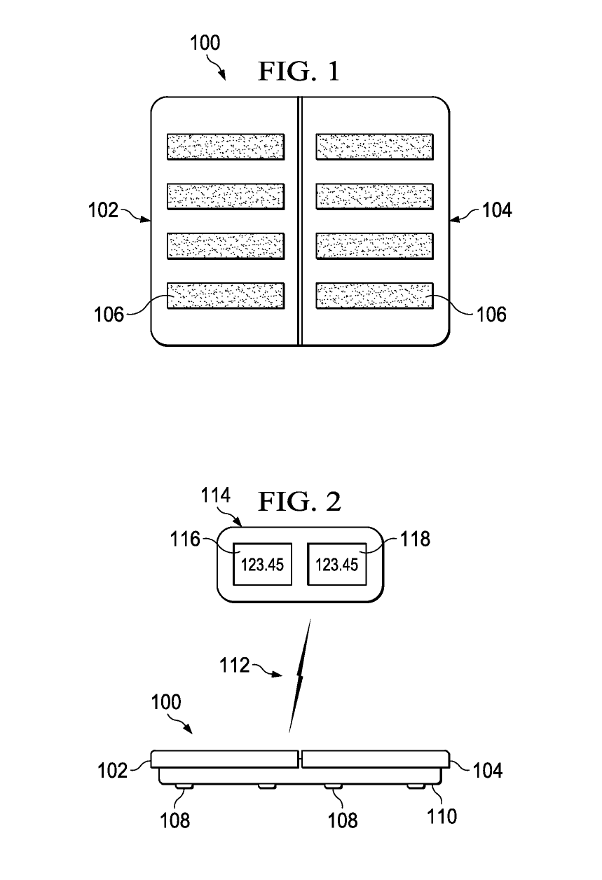

FIGS. 1, 2, and 3 depict an embodiment of the present disclosure having bilateral scale 100. FIG. 1 shows a top view of bilateral scale 100. Bilateral scale 100 has first scale plate 102 and second scale plate 104. One skilled in the art will recognize that the number of scale sections may vary depending on the use thereof and would remain within the scope and spirit of the present disclosure. First scale plate 102 is operatively independent from second scale plate 104 such that weight placed on the first scale plate 102 will not register as weights placed on second scale plate 104. Each of the first scale plate 102 and second scale plate 104 may include surfaces 106 designed for use in a physical therapy and/or training environment. For example, the surface 106 may be made of rubber or a gel to provide some cushion and traction to a user, and be easily cleanable to maintain sanitary conditions in a physical therapy and training environment. First scale plate 102 and second scale plate 104 are both depicted as generally rectangular shapes with curved exterior corners with each side approximately equal in size. One skilled in the art will recognize that the size and shape of each scale plate may vary and remain within the scope and spirit of the present disclosure.

FIG. 2 shows a side view of bilateral scale 100 in conjunction with system display 114. First scale plate 102 and second scale plate 104 are above support plate 110. Support plate 110 provides a base across a substantial portion of bilateral scale 100 against which pressure sensors for each of first scale plate 102 and second scale plate 104 contact. In addition, attached to support plate 110 are feet 108 which provide contact with the underlying surface. In some embodiment, feet 108 may be fitted to the underlying surface. In other embodiments, feet 108 may be made with a traction improving design and/or material. In some embodiments, feet 108 are adjustable such that each foot 108 may be adjusted to raise or lower bilateral scale 100 and/or allow for bilateral scale 100 to be leveled.

System display 114 is wirelessly connected to bilateral scale 100 by signal 112. Data registered by bilateral scale 100, such as pressure readings associated with each of first scale plate 102 and second scale plate 104, is transmitted to system display 114 via signal 112. Data may be processed by bilateral scale 100, system display 114, and/or an independent device (not shown). System display 114 is shown with a first display section 116 and a second display section 118. The display section 116 and 118 may be used independent from each other or as part of a singular display. For example, first display section 116 may display readings from first scale plate 102 and second display section 118 may display readings from second scale plate 104. As another example, first display section 116 may display user information and history while second display section 118 displays readings from first scale plate 102 and second scale plate 104, and displays a combined result from first scale plate 102 and second scale plate 104. One skilled in the art will recognize that number of displays as well as the size, shape, and functionality of the display may vary and remain within the scope and spirit of the present disclosure. In addition, system display 114 may be any type of display, such as an LED display or LCD display. One skilled in the art will recognize that weight distribution may be displayed in a variety of ways, such as English or metric measurements and/or percent distributions, and remain within the scope and spirit of the present disclosure.

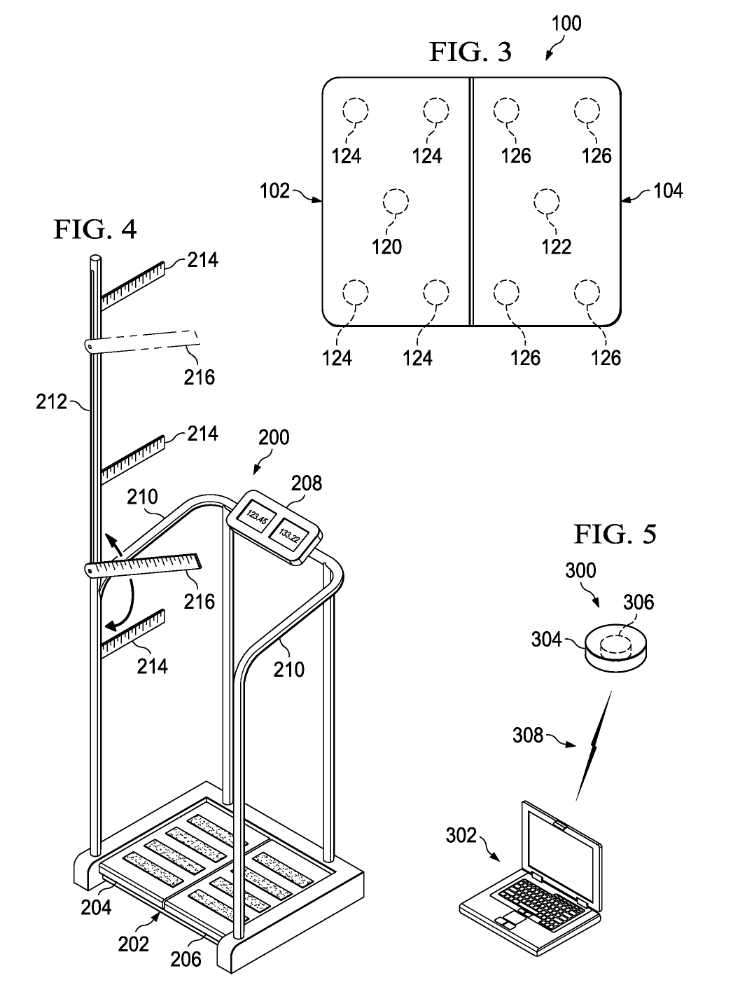

FIG. 3 shows a modified top view of bilateral scale 100 depicting an embodiment of a pressure sensor layout. In this embodiment, between first scale plate 102 and support plate 110 are first central pressure sensor 120 and first corner sensors 124, and between second scale plate 104 and support plate 110 are second central pressure sensor 122 and second corner sensors 126. Pressure sensors 120 and 124 may combine to determine the weight distributed on first scale plate 102. In addition, independent readings from each of pressure sensors 120 and 124 may be used to more accurately determine how the pressure is distributed across first scale plate 102. For example, two of pressure sensors 124 located at a front of bilateral scale 100 may register higher pressures than pressure sensors 124 located at a rear of bilateral scale 100 indicating a higher distribution of weight to the front of first scale plate 102. Similarly, pressure sensors 122 and 126 may combine to determine the weight distributed on second scale plate 104 or be independently analyzed to determine how the pressure is distributed across second scale plate 104.

Bilateral scale 100 may include a microprocessor to control operation and operatively connect with system display 114. For example, operation of the system may be controlled by tapping the pressure sensitive scale plates 102 and 104 during a set-up or initialization phase of operation. Alternatively, a separate user interface may be integrated into or otherwise operatively associated with bilateral scale 100 or system display 114. The system may be powered by a portable power source, a wired electrical connection, or any other form of power source and remain within the scope and spirit of the present disclosure.

After the scale has been initialized, calibrated, and the desired functionality selected, a person may use bilateral scale 100 by standing on the scale with their first foot placed on the first scale plate 102 and their second foot placed on the second scale plate 104. While the person stands on bilateral scale 100, the pressure sensors 120, 122, 124, and 126 determine the weight distribution of the person. For example, for a 200 lbs person, the pressure sensors 120, 122, 124, and 126 may register 90 lbs of weight on their left side and 110 lbs of weight on their right side. Such a distribution would indicate that the person is carrying 20 lbs more on right side than their left. In addition, the weight distribution across each plate 102 and 104 may further indicate that the person is carrying the majority of the 90 lbs on the ball of the left foot, while the 110 lbs is carried evenly on the right foot. Various data may be shown on system display 114 regarding the pressure sensor readings and/or stored or input information. For example, system display 114 may show “90 lbs” on first display section 116 and “110 lbs” on second display section 118. In addition, first display section 116 may indicate that the ball of the left foot is carrying more weight than the heel and more specifically, that the ball of the left foot is carrying 65 lbs while the heel is carrying 25 lbs, and the second display section 118 may indicate that weight on the right foot is distributed evenly. During the time a person is standing on bilateral scale 100, the pressure sensors 120, 122, 124, and 126 may provide continuous readings that vary reflecting changes in weight distribution. System display 114 may show these continuous readings while the person is standing, the initial pressure readings, peak pressure readings, and/or the display may show an average weight distribution on each plate 102 and 104.

A physical trainer, physical therapist, or chiropractic care provider may utilize bilateral scale 100 to evaluate the bodyweight distribution and posture of a person. The physical trainer or therapist may request a person to stand on bilateral scale 100 as described above and review system display 114 for weight distribution measurements. In conjunction with the output of system display 114, the physical trainer or therapist may observe the person's physical posture during the evaluation. Based upon consideration of both a person's posture and actual weight distribution, a physical trainer or therapist may evaluate whether the posture is consistent with the weight distribution and/or if corrective efforts should be considered. For example, a physical therapist may determine that a person's right lower extremity bears more weight than the left side in a consistent manner with the lean in posture to the right, and that corrective efforts, such as neuromuscular reeducation, to should be take to shift the posture and weight distribution to the center of the person's body. For another example, a physical therapist may determine that corrective measures should be taken because a person appearing to have proper posture is compensating for a physical ailment on their right side by shifting their weight to the left lower extremity as observed on system display 114. As another example, a physical therapist may determine that a person has a central posture and even weight distribution and does not need any corrective measures.

FIG. 4 depicts a bodyweight distribution and posture evaluation station 200. Station 200 includes bilateral scale 202 having a first scale section 204 and a second scale section 206. Bilateral scale 202 may operate in a similar manner to bilateral scale 100 described above. System display 208 is mounted on support structure 210 and may provide display capabilities including those described above for system display 114. Support structure 210 may be used to assist a user with reaching a standing position and/or balancing on bilateral scale 202. However, one skilled in the art will recognize that accuracy of the weight distribution evaluation may be compromised if a person is utilizing support structure 210 to improve their natural balance and/or shift their weight during an evaluation. In some embodiments a user will use support structure before and/or after an evaluation, but will not utilize support structure 210 during an evaluation. In other embodiments, a user may utilize support structure 210 during an evaluation in conjunction with accessory weight distribution devices and methods discussed further below.

Support pole 212 is shown with measurement devices 214 and 216 attached. Lateral measurement devices 214 may be utilized to make plumb line measurements of a person's posture from a side view. Such plumb line measurements may determine if and to what extent a person's posture leans forward and/or backward. In this embodiment, lateral measurement devices 214 are depicted as a set of three measurement devices extending in a first direction from support pole 212 approximately parallel to the surface of bilateral scale 202 and provide observable demarcations to measure a person's posture.

Anterior/posterior measurement device 216 may be utilized to make plumb line measurements of a person's posture from a rear or front view. In this embodiment, anterior/posterior measurement device 216 is adjustably attached to support pole 212 such that it may be in a rotatably positioned next to support pole 212 while a person is moving onto and/or off of bilateral scale 202, and may be rotatably adjusted to be approximately parallel to the surface of bilateral scale 202 and approximately perpendicular to lateral measurement devices 214. In addition, anterior/posterior measurement device 216 is vertically adjustable with support pole 212 such that anterior/posterior measurement device 216 may be used to record various plumb line measurements along the back or front of a person. The vertical adjustment is depicted in FIG. 4 by the dotted representation of anterior/posterior measurement device 216.

One skilled in the art will recognize that other devices may be utilized in conjunction with or in place of measurement devices 214 and 216 to determine a person's plumb line measurements and remain within the scope and spirit of the present disclosure. For example, a computer with optical sensors may be utilized to capture standing images and overlay those images on a scaled grid to depict a leaning posture and measure the extent of the lean. With such a system, the images and grid may be depicted on display 208 for the person to observe any lean in posture. For another example, an optical device may output a visible vertical line on the person for the physical therapist to observe and measure a person's posture in the context of said vertical line.

Station 200 may be used by a physical trainer, physical therapist, or chiropractic care provider to evaluate and quantify a person's bodyweight distribution and posture. A person's bodyweight distribution may be determined by bilateral scale 202 similar to the method of determining bodyweight distribution described above for bilateral scale 100. While a person is on bilateral scale 202, the physical therapist may utilize lateral measurement devices 214 to evaluate the plumb line measurements of a person's posture from the side. The physical therapist may make observable measurements of landmarks on the person's body such as the lobe of the ear, the shoulder joint, approximately midway between the front and back of the chest, the hip joint, slightly in-front of the knee joint, and slightly in-front of the ankle joint. In addition, the physical therapist may utilize anterior/posterior measurement devices 216 to evaluate the plumb line measurements of a person's posture from the back. The physical therapist may make observable measurements of landmarks on the person's body such as the mid-line of the superior nuchal line, the cervical level 7 (C-7), the midline between the bilateral inferior angles of the scapulae, the thoracic level 10 (T-10), and the mid-line between the bilateral posterior superior iliac spine (PSIS). Alternatively, if the person is facing away from display 208, the physical therapist may utilize anterior/posterior measurement devices 216 to evaluate the plumb line measurements of a person's posture from the front. The physical therapist may make observable measurements of landmarks on the person's body such as the mid-line of the frontal bone, the midline of the nasal bone, the xyphoid process, the umbilicus, and the mid-line between the bilateral anterior superior iliac spine (ASIS). One skilled in the art will recognize that the number and identification of landmarks used to establish plumb line measurements by a physical therapist may vary and remain within the scope and spirit of the present disclosure.

In this embodiment, support pole 212 is shown at a corner of bodyweight distribution and posture evaluation station 200, but one skilled in the art will recognize that support pole 212 may at any point along the exterior of bodyweight distribution and posture evaluation station 200 and the position of support pole 212 may further be adjustable. For example, support pole 212 may be placed on one side wherein support pole 212 is in line with at least one point of reference for a person's lateral plumb line measurements (e.g., the shoulder joint) and a physical therapist may measure the variation in lateral plumb line body landmarks from support pole 212. In such an example, lateral measurement devices 214 may extend from both sides of support pole 212 to provide a standard in which to measure a forward or backward lean in a person's posture. Support pole 212 may then be placed in front of a person to measure the plumb line deviation to evaluate a person's posture.

In some embodiments, system 200 includes a computer system to record and evaluate measurements from bilateral scale 202. While the person is standing on bilateral scale 202 and the physical therapist is observing the person's posture using measurement devices 214 and 216, bilateral scale 202 may record pressure measurements and provide information based upon the recording over a specified timeframe. Such information may include average weight distribution characteristics, peak weight distribution characteristics, and/or median weight distribution characteristics. An analysis of weight distribution characteristics over time may decrease the possibility of manufactured results by a person attempting to disguise an unbalanced bodyweight distribution.

FIG. 5 depicts an embodiment of a portable bodyweight distribution and posture evaluation system 300. System 300 includes a portable computer 302 and at least one portable weight distribution accessory 304. One of skill in the art will recognize that portable computer 302 may be any portable computing device such as a smart phone, a laptop computer, a tablet, or a specialized computing device and remain within the scope and spirit of the present disclosure. Other embodiments of system 300 may include static and portable components for portable computer 302. For example, a static computing server may be placed in one room of a physical therapist's facility and a portable display associated with the computing server may be operable throughout the physical therapist's facility.

Accessory 304 includes at least one pressure sensor 306 to determine pressure placed on accessory 304. Accessory 304 is illustrated as a generally circular shaped pad, but accessory 304 may be designed as any shape or size. For example, accessory 304 may be a glove having pressure sensor 306 across the palm portion of the glove, wherein a person using a hand-held assistive device in the gloved hand may determine the pressure placed on the assistive device. Alternatively, accessory 304 may be designed for placement on an assistive device to register pressures applied to the assistive device. One skilled in the art will recognize that assistive devices include but are not limited to parallel bars, walkers, axillary crutches, forearm crutches, AFO (ankle-foot orthotic), KAFO (knee-ankle-foot orthotic), HKAFO (hip-knee-ankle-foot orthotic) and canes (NBQC (narrow based quad cane), WBQC (wide based quad cane), single tip cane). One skilled in the art will recognize that other embodiments may use pressure sensors 306 built into assistive devices. For example, a cane may have a pressure sensor built into the handle and/or foot to register pressures applied to the cane.

Portable computer 302 is depicted as wirelessly connected to accessory 304 by signal 308. One skilled in the art will recognize that signal 308 may alternatively be communicated by wire or other means. Pressure readings from sensor 306 are transmitted by a wireless transmitter to portable computer 302. Portable computer 302 may provide data regarding the pressure readings on a display or other output mechanism. In addition, portable computer 302 may analyze the pressure readings from sensor 306 in conjunction with additional data stored, retrieved, input, and/or provided to portable computer 302 and may output the additional data and/or information based upon such analysis.

In some embodiments, system 300 includes a plurality of accessories 304 that are used to register multiple pressure readings and evaluate weight distribution across the plurality of accessories 304. In other embodiments, system 300 may include a wirelessly connected bilateral scale, such as those described above. Such an embodiment may improve an evaluation of bodyweight distribution for people in need of assistive devices. For example, a person on a bilateral scale 100 may also use a cane having accessory 304 on the handle. Portable computer 302 can record readings from pressure sensors associated with bilateral scale 100 and accessory 304, and may analyze and/or output pertinent information. For example, based upon pressure readings over a two minute period, portable computer 302 displays the average weight distribution for each section of bilateral scale 100 and for accessory 304 in each of three screen sections. The results may show that a person weighing 200 lbs is carrying on average 100 lbs on their left foot, 90 lbs on their right foot, and 10 lbs on the cane in their right hand. If these numbers indicate a reasonable weight distribution with utilization of a cane for balance, the display may indicate that the numbers are within an acceptable range. If these numbers indicate an unreasonable weight distribution with utilization of a cane for balance, the display may indicate that the numbers are outside of an acceptable range and/or that corrective measures should be considered. In addition, results of the evaluation may be stored for historical reference and/or transmitted to the person's physical therapist, doctor, and/or any other person approved by the person.

In other embodiments of system 300, a person or physical trainer may utilize accessory 304 or a plurality thereof to monitor and evaluate weight distribution during an exercise or other training session. For example, an accessory 304 may be placed in, attached to, and/or integrated into each shoe of a person wherein each accessory 304 may utilize multiple pressure sensors 306 to evaluate weight distribution across each foot. During activities including but not limited to running, jumping, walking, weight lifting, and biking portable computer 302 may monitor and record pressure readings from each of pressure sensors 306. Such pressure readings may indicate if a person is favoring one lower extremity over the other, maintaining center of balance, maintaining a proper weight distribution upon each foot, and/or other information. For example, a person may jump up to an elevated surface and back down to a lower surface wearing shoes with integrated accessories 304. During the exercise a trainer may monitor the pressure results to ensure the person is landing with an even weight distribution across each lower extremity. Such measurements may reflect the weight distribution at the initial impact and may further indicate if one foot is landing prior to the other. In addition, the physical trainer may wish to monitor whether the person is maintaining a majority of their weight in the balls of each foot to improve certain muscular groups. Finally, the physical trainer may instruct the person with any corrective measures to improve the weight distribution and the exercises desired effect.

Accessory devices 304 may also be incorporated into gloves to monitor weight distribution during activities including but not limited weight lifting, push-ups, and gymnastics. For example, after a person bench-presses a selected weight, a physical trainer can use portable computer 302 to review the weight distributed in each hand in order to ensure the bar is lifted and lowered evenly.

In another embodiment of system 300, portable computer 302 is further associated with one or more optical devices. Such optical devices may be used as described above to evaluate a person's posture through analysis of plumb line measurements. In addition, optical devices may be used in conjunction with accessories 304 to evaluate a person's shifting center of balance during activities including but not limited to gymnastics, football, and ballet. For example, a physical trainer may review weight distribution in conjunction with an image of a football player practicing movement while maintaining a low center of gravity. The physical trainer may be able to analyze the person's center of balance while leaning during a quick turn by selecting the pertinent images and reviewing the corresponding weight distribution results from accessories 304 in the shoes of the person and in the fingers and palm of the person's gloves. Alternatively, portable computer 302 may provide an analysis and depict the person's calculated center of gravity on the pertinent images. Such an analysis may assist the physical trainer in developing methods to emphasize a person's speed, power, and/or control during such activities.

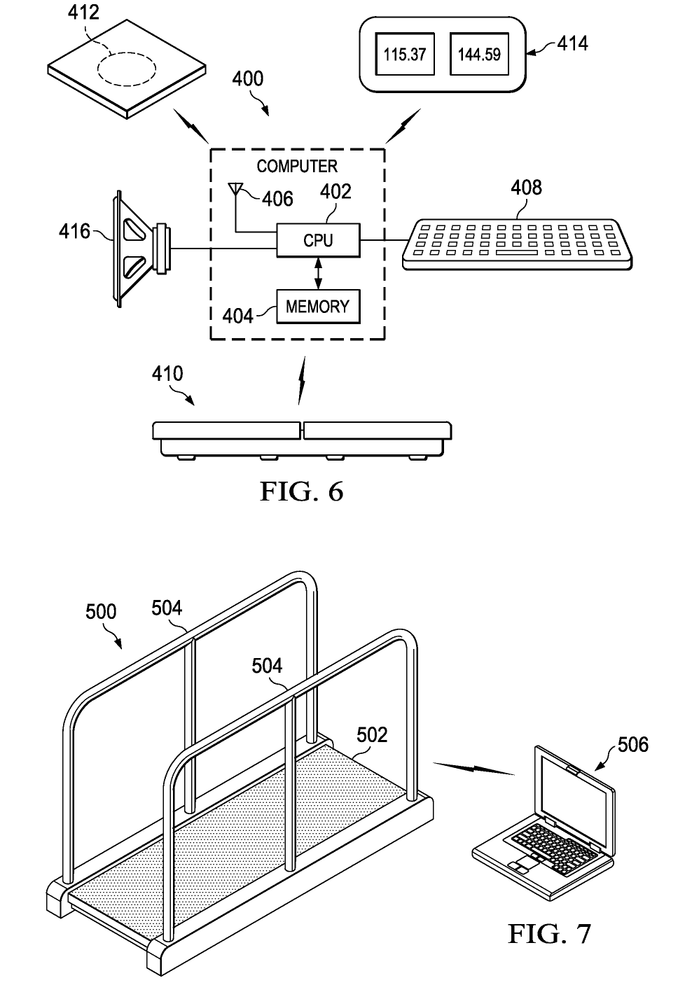

Another embodiment of a bodyweight distribution system is shown in FIG. 6 as a computer 400 associated with various internal and external components. Internal to computer 400 is a microprocessor 402 associated with memory 404 and a wireless transceiver 406. Memory 404 may comprise random access memory, read only memory, or any other electronic storage component. External to computer are a user interface shown as keyboard 408, bilateral scale 410, weight distribution accessory 412, and outputs shown as display 414 and speaker 416. One skilled in the art will recognize that placement and/or integration of the various components may vary and remain within the scope and spirit of the present disclosure. One skilled in the art will also recognize that alternative user interface and output components may be utilized in conjunction with or instead of the depicted user interface and outputs.

The bodyweight distribution system shown in FIG. 6 may operate in the same manner as systems described above. In this embodiment, pressure readings are measured by bilateral scale 410 and accessory 412. Each device transmits these pressure readings as wireless signals to computer 400. Computer 400 receives these wireless signals via transceiver 406. The pressure readings are then processed by microprocessor 402. Microprocessor 402 may store the data in memory 404, output the data to display 414 and/or speaker 416, and/or analyze the data further. Any data analysis by microprocessor 402 may be based upon algorithms stored in memory 404, additional data stored in memory 404, and/or data received from a user interface, such as wired keyboard 408. For example, microprocessor 402 may provide an initial output on display 414 showing the weight distribution across each section of bilateral scale 410 and accessory 412. In addition, microprocessor 402 may output a generally descriptive statement, such as “5 percent lean to the left,” via speaker 416. Microprocessor 402 may also analyze the received weight distribution readings in conjunction with historical weight distribution readings and output a graph showing how the weight distribution is trending. In addition, microprocessor 402 may output data via an associated printer so that the person may take a copy of their results and historical results. Such an output may also be sent to a medical provider or insurance provided to show improvement in weight distribution over time. The quantifiable documentation may provide an additional benefit of improving insurance reporting and collections.

FIG. 7 depicts an embodiment of a bodyweight distribution evaluation system including an assistive device. Ambulatory bodyweight distribution system 500 includes pressure sensitive mat 502 placed on a supportive surface between parallel bars 504. Both pressure sensitive mat 502 and parallel bars 504 include integrated pressure sensors throughout. Pressure readings from the various pressure sensors in system 500 are transmitted to computer 506. In this embodiment, computer 506 is shown as a laptop computer, but one skilled in the art will recognize that the system 500 may utilize any computer, tablet, smart phone, or other device with sufficient data processing and communication capabilities remain within the scope and spirit of the present disclosure. Computer 506 may record and/or display pressure readings and their associated locations on ambulatory system 500.

A person may use the system by walking on pressure sensitive mat 502 and using parallel bars 504 as an assistive device as needed. Pressure sensors in pressure sensitive mat 502 register weight distribution between a person's lower extremities and further register weight distribution across each foot as the person walks. In addition, when the parallel bars 504 are utilized the integrated pressure sensors register the location and weight distribution on each parallel bar 504. For example, a person weighing 200 lbs learning to use a prosthetic lower left leg may take a few steps without assistance from parallel bars 504, and pressure sensitive mat 502 may register an average of 120 lbs on the right leg and 80 lbs on the left leg. The person may begin to utilize parallel bars 504 for additional support as they tire. During which time, pressure sensitive mat 502 may register an average of 90 lbs on the right leg and 50 lbs on the left leg while pressure sensors in parallel bars 504 may register 20 lbs on the right side of the person and 40 lbs on the left side of the person.

In addition to weight distribution readings, a physical therapist may monitor the person's gait pattern for the manner in which a person walks and the posture they maintain while ambulating. In some embodiments, system 500 may include additional components such as optical devices, to record and/or monitor the person's gait patterns. Utilizing observations of gait patterns along with the weight distribution readings, a physical therapist may evaluate whether a person needs to take corrective measures to improve posture and/or weight distribution while walking.

In other embodiments, a pressure sensitive mat 502 may be designed for and used in a hospital bed or wheelchair to monitor whether a person is adjusting bodyweight as necessary to prevent and/or minimize skin breakdown, such as bed sores. The system would monitor pressure and time spent in a given position. An alarm or warning may be provided to the user and/or a healthcare professional if the time spent in one position and/or the amount of pressure reaches a designated or calculated threshold.

One skilled in the art will recognize that some embodiments of the systems may be worn or used by a person out side of a physical training, physical therapy, or medical facility. Such systems may monitor and record a person's weight distribution in their everyday activities. The recorded weight distribution data may be provided to a healthcare provider, physical trainer, physical therapist, and/or other designated person by electronic transmission in real-time, on a scheduled basis, and/or when some data threshold is reached, such as the amount of data collected, the amount of pressure, the lack of pressure readings, and/or other designated thresholds. For example, a physical therapist may review the weight distribution readings of a patient to ensure that the patient is taking advised corrective action outside of scheduled physical therapy sessions. In addition, the recordings in everyday activities may provide a more accurate representation of a person's natural weight distribution as opposed to weight distribution measured in the physical therapy facility where a patient may attempt to disguise ailments.

The invention being thus described, it will be obvious that the same may be varied in many ways. Such variations are not to be regarded as a departure from the spirit and scope of the invention and all such modifications as would be obvious to one skilled in the art are intended to be included within the scope of the system, method, or apparatus described.

What is claimed:

1. A weight distribution apparatus, comprising:
a support structure;
a first weight distribution surface and a second weight distribution surface located above said support structure, wherein said first and second weight distribution surfaces are independently operable;
at least one first pressure sensor located between said first weight distribution surface and said support structure, wherein said first pressure sensor determines a first weight applied to said first weight distribution surface;
at least one second pressure sensor located between said second weight distribution surface and said support structure, wherein said second pressure sensor determines a second weight applied to said second weight distribution surface; and
at least one display operatively associated with said first pressure sensor and said second pressure sensor, wherein said display shows at least one of said first weight and said second weight and a weight distribution based upon said first weight and said second weight.

2. The weight distribution apparatus of claim 1, comprising:
at least five first pressure sensors located between said first weight distribution surface and said support structure with at least one said pressure sensor located approximately in each of a central location, a forward-right location, a forward-left location, a rear-left location, and a rear-right location of said first weight distribution surface, wherein said first pressure sensors determine a first weight applied to said first weight distribution surface and a first weight distribution across said first weight distribution surface; and
at least five second pressure sensors located between said second weight distribution surface and said support structure with at least one said pressure sensor located approximately in each of a central location, a forward-right location, a forward-left location, a rear-left location, and a rear-right location of said second weight distribution surface, wherein said second pressure sensors determine a second weight applied to said second weight distribution surface and a second weight distribution across said second weight distribution surface.

3. The weight distribution apparatus of claim 1, comprising an assistive support structure, wherein said assistive support structure provides at least one of a balance support or a weight distribution support.

4. The weight distribution apparatus of claim 3, wherein said assistive support comprises at least one handhold located above said first and second weight distribution surfaces, wherein when a user stands on said first and second weight distribution surfaces, said assistive support provides a user with assistance in at least one of balance or weight distribution.

5. The weight distribution apparatus of claim 1, comprising a posture measurement device, wherein said posture measurement device is positioned to measure at least one of a lateral plumb line of a person, an anterior plumb line of said person, and a posterior plumb line of said person.

6. The weight distribution apparatus of claim 5, wherein said posture measurement device comprises a vertical structure having at least one extension, wherein said extension provides a standard against which to measure at least one of said lateral plumb line of said person, said anterior plumb line of said person, and said posterior plumb line of said person.

7. The weight distribution apparatus of claim 6, wherein said extension is at least one of vertically adjustable and rotatably adjustable.

8. The weight distribution apparatus of claim 5, wherein said posture measurement device comprises an optical device that measures at least one of said lateral plumb line of said person, said anterior plumb line of said person, and said posterior plumb line of said person.

9. The weight distribution apparatus of claim 5, wherein said posture measurement device comprises an optical device wherein said optical device outputs a visible image upon said person providing a standard against which to measure at least one of said lateral plumb line of said person, said anterior plumb line of said person, and said posterior plumb line of said person.

10. The weight distribution apparatus of claim 1, comprising a processor, wherein said processor analyzes an output from said at least one first pressure sensor and an output from said at least one second pressure sensor.

11. The weight distribution apparatus of claim 10, comprising an alternate data source, wherein said processor analyzes data from said alternate data source, wherein said data comprises at least one of historical data, a personal identification data, medical data, and therapeutic data.

12. The weight distribution apparatus of claim 11, wherein said alternate data source comprises at least one of a memory device, a user interface, a computer network, and an operatively associated diagnostic tool.

13. The weight distribution apparatus of claim 10, comprising an accessory weight distribution device operatively associated with said processor, wherein said accessory weight distribution device comprises at least one accessory pressure sensor.

14. The weight distribution apparatus of claim 13, wherein said accessory weight distribution device comprises at least one of a glove, a shoe, a pad, a mat, and an assistive device.

15. A method of evaluating weight distribution, comprising steps of:
determining a person's weight applied to a bilateral pressure sensitive device, wherein said bilateral pressure sensitive device comprises at least one first pressure sensor and at least one second pressure sensor, wherein said at least one first pressure sensor and said at least one second pressure sensor are independently operable, wherein said first pressure sensor determines a first weight applied to said first pressure sensor and said second pressure sensor determines a second weight applied to said second pressure sensor;
analyzing said first weight and said second weight, wherein said analysis comprises determining a weight distribution between said first pressure sensor and said second pressure sensor; and
providing an output based upon said analysis.

16. The method of evaluating weight distribution of claim 15, comprising applying said person's first lower extremity to said first pressure sensor and applying said person's second lower extremity to said second pressure sensor, wherein said first weight indicates the amount of weight in said first lower extremity and said second weight indicates the amount of weight in said second lower extremity.

17. The method of evaluating weight distribution of claim 16, comprising
determining additional weight of said person applied to an accessory device comprising an accessory pressure sensor, wherein said accessory pressure sensor determines an accessory weight applied to said accessory pressure sensor;
analyzing said accessory weight, wherein said analysis comprises determining said weight distribution among said first pressure sensor, said second pressure sensor, and said accessory pressure sensor; and
providing said output based upon said analysis.

18. The method of evaluating weight distribution of claim 17, wherein said accessory device is at least one of a glove, a shoe, a pad, and an assistive device.

19. The method of evaluating weight distribution of claim 16, comprising
determining additional weight of said person applied to an assistive device;
analyzing said additional weight, wherein said analysis comprises determining said weight distribution among said first pressure sensor, said second pressure sensor, and said assistive device; and
providing said output based upon said analysis.

20. The method of evaluating weight distribution of claim 19, wherein said assistive device comprises at least one of a set of parallel bars, a walker, an axillary crutch, a forearm crutch, and a cane.

21. The method of evaluating weight distribution of claim 15, wherein said bilateral pressure sensitive device comprises a bilateral scale, wherein said bilateral scale comprises:
a first weight distribution surface and a second weight distribution surface located above a support structure, wherein said first pressure sensor is located between said first weight distribution surface and said support structure and second pressure sensor is located between said second weight distribution surface and said support structure; and
at least one display, wherein said display shows said output.

22. The method of evaluating weight distribution of claim 15, wherein said bilateral pressure sensitive device comprises a pressure sensitive mat, wherein said pressure sensitive mat comprises said first pressure sensor and said second pressure sensor.

23. The method of evaluating weight distribution of claim 22, comprising the steps of
determining said person's dynamic weight distribution applied to said pressure sensitive mat, wherein said pressure sensitive mat comprises a plurality of said first pressure sensors and a plurality of said second pressure sensors, wherein said plurality of said first pressure sensors determine a dynamic first weight applied by said person's first lower extremity and said plurality of said second pressure sensors determine a dynamic second weight applied by said person's second lower extremity;
storing said dynamic first weight, wherein said dynamic first weight comprises data based upon a collection of determined said first weights associated with times and locations of said determined first weights;
storing said dynamic second weight, wherein said dynamic second weight comprises data based upon a collection of determined said second weights associated with times and locations of said determined second weights;
analyzing said dynamic first weight and said dynamic second weight, wherein said analysis determines a weight distribution between said plurality of said first pressure sensors and said plurality of said second pressure sensors; and
providing an output based upon said analysis.

24. The method of evaluating weight distribution of claim 23, wherein said output indicates at least one of an average weight distribution between said plurality of said first pressure sensors and said plurality of said second pressure sensors over said collections, an instantaneous weight distribution between said plurality of said first pressure sensors and said plurality of said second pressure sensors at a selected time, and a change in weight distribution between said plurality of said first pressure sensors and said plurality of said second pressure sensors over said collections.

25. The method of evaluating weight distribution of claim 23, comprising the steps of
determining said person's dynamic weight distribution applied to an assistive device, wherein said assistive device is operatively associated with a plurality of accessory pressure sensors, wherein said plurality of accessory pressure sensors determine a dynamic accessory weight applied by said person;
storing said dynamic accessory weight, wherein said dynamic accessory weight comprises data based upon a collection of determined accessory weights associated with times and locations of said determined accessory weights;
analyzing said dynamic accessory weight, wherein said analysis determines a weight distribution between said plurality of said first pressure sensors, said plurality of said second pressure sensors, and accessory pressure sensors; and
providing an output based upon said analysis.

26. The method of evaluating weight distribution of claim 25, wherein said assistive device comprises a set of bars located along opposite sides of said pressure sensitive mat and comprise said plurality of accessory pressure sensors.
